(19) United States
(12) Patent Application Publication
(10) Pub. No.: US 2026/0242087 A1
(43) Pub. Date: Aug. 20, 2026

(54) ARTICLE PACKAGING APPARATUS, PACKAGING APPARATUS, AND PACKAGING SYSTEM

(71) Applicant: SOFTBANK GROUP CORP., Tokyo (JP)

(72) Inventor: Masayoshi SON, Tokyo (JP)

(21) Appl. No.: 19/155,006

(22) PCT Filed: Feb. 8, 2024
(86) PCT No.: PCT/JP2024/004368

§ 371 Date: Aug. 8, 2025

(30) Foreign Application Priority Data
Feb. 9, 2023 (JP) 2023-018552
Apr. 11, 2023 (JP) 2023-064218
Apr. 17, 2023 (JP) 2023-067389

(51) Int. Cl. B65B 57/12; B65B 5/06; B65B 5/08

(52) U.S. Cl. CPC B65B 57/12; B65B 5/06; B65B 5/08; B65B 2210/04

(57) ABSTRACT

An article packaging apparatus includes an identification unit and a packaging unit. The identification unit identifies whether or not an article is a specific article unsuitable for being grabbed by a robot arm. When the article is the specific article, the packaging unit packages the article such that the specific article can be grabbed by the robot arm.

### FIELD

The disclosed embodiments relate to an article packaging apparatus, a packaging apparatus, and a packaging system.

### BACKGROUND

There has been known, for example, a technique of storing an article in a container for safekeeping and storing, in a depository, the container for safekeeping in which the article is stored (see, for example, Patent Literature 1).

### CITATION LIST

### Patent Literature

Patent Literature 1: JP 2022-180082 A

### SUMMARY

### Technical Problem

When the article is taken out from the container for safekeeping, the article is sometimes taken out from the container for safekeeping by a robotic arm. However, depending on an article, it is sometimes difficult to grab the article with the robot arm.

The present invention has been made in view of the above, and an object of the present invention is to make it easy to grab an article with a robot arm.

### Solution to Problem

An article packaging apparatus according to an aspect of an embodiment includes an identification unit and a packaging unit that. The identification unit identifies whether or not an article is a specific article unsuitable for being grabbed by a robot arm. When the article is the specific article, the packaging unit packages the article such that the specific article can be grabbed by the robot arm.

A packaging apparatus according to an aspect of an embodiment includes an identification unit and a packaging unit. The identification unit identifies whether or not at least one article stored in a box is a specific article unsuitable for being grabbed by a robot arm. When the article is the specific article, the packaging unit takes out the article that is the specific article from the box and packages the article taken out from the box such that the specific article can be grabbed by the robot arm.

An article packaging apparatus according to an aspect of an embodiment includes an identification unit, a selection unit, and a packaging unit. The identification unit identifies whether or not one predetermined article among a plurality of articles is a specific article unsuitable for being grabbed by a robot arm. When the predetermined article is identified as the specific article, the selection unit selects, out of the plurality of articles, an article that can be bundled with the specific article. The packaging unit collectively packages the specific article and the article that can be bundled such that the specific article can be grabbed by the robot arm.

### Advantageous Effects of Invention

According to the aspect of the embodiment, it is possible to make it easy to grab an article with a robot arm.

### BRIEF DESCRIPTION OF DRAWINGS

FIG. 1 is a block diagram illustrating an overview of a distribution center.

FIG. 2 is a diagram illustrating an overview of a shipping unit.

FIG. 3 is a diagram illustrating an overview of a packaging apparatus.

FIG. 4 is a control system block diagram of an information processing device.

FIG. 5 is a flowchart for explaining packaging processing according to a first embodiment.

FIG. 6 is a diagram schematically illustrating an example of a computer hardware configuration functioning as an information processing device.

FIG. 7 is a block diagram illustrating an overview of a distribution center.

FIG. 8 is a diagram illustrating an overview of a packaging system and a packaging apparatus.

FIG. 9 is a flowchart for explaining packaging processing according to a second embodiment.

FIG. 10 is a diagram illustrating an overview of a packaging apparatus.

FIG. 11 is a diagram illustrating an example of bundle information.

FIG. 12 is a diagram illustrating an example of order information.

FIG. 13 is a flowchart for explaining packaging processing according to a third embodiment.

### DESCRIPTION OF EMBODIMENTS

Hereinafter, the present invention is explained through embodiments. However, the embodiments explained below do not limit the invention according to the claims. Not all of combinations of characteristics explained in the embodiments are essential to the solution of the invention.

### First Embodiment

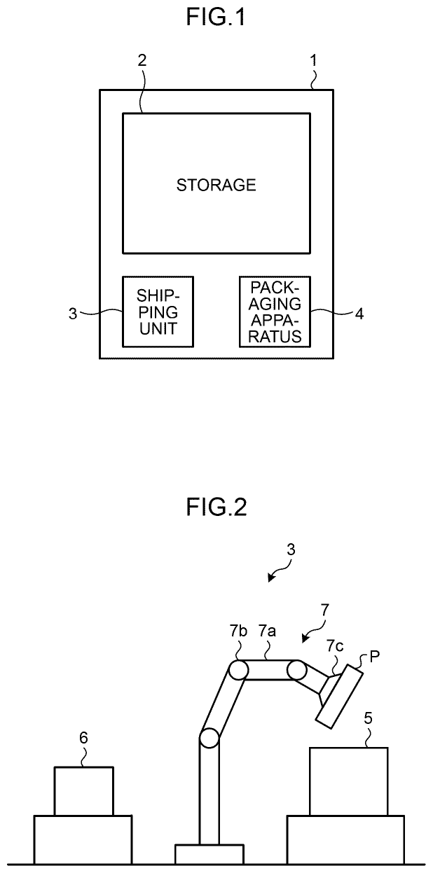

For example, as illustrated in FIG. 1, a packaging apparatus 4 according to a first embodiment is provided in a distribution center 1. FIG. 1 is a block diagram illustrating an overview of the distribution center 1.

The distribution center 1 includes a storage 2, a shipping unit 3, and a packaging apparatus 4. The storage 2 is a shelf or the like for safekeeping articles. The articles are, for example, commodities. In the storage 2, the articles are safekept in a state of being stored in a commodity box 5 (a tote and a basket).

The articles safekept in the storage 2 are taken out from the storage 2 by, for example, a cart robot based on delivery information and are conveyed to the shipping unit 3. For example, the cart robot takes out the commodity box 5 storing the articles from the storage 2 and conveys the taken-out commodity box 5 to the shipping unit 3. The delivery information explained above is information concerning delivery of the articles and is, for example, information including a list of articles instructed in advance to be delivered and a list of articles delivered in response to an order for the articles (order information).

The shipping unit 3 takes out an article P from the conveyed commodity box 5 and transfers the article P to a delivery box 6 (for example, corrugated cardboard) for shipping. As illustrated in FIG. 2, the shipping unit 3 includes a robot arm 7. FIG. 2 is a diagram illustrating an overview of the shipping unit 3. The shipping unit 3 takes out the article P from the commodity box 5 with the robot arm 7 and stores the article P in the delivery box 6 with the robot arm 7. The delivery box 6 storing the article is shipped from the distribution center 1.

The robot arm 7 includes a plurality of rod sections 7a and a plurality of joint sections 7b. The joint section 7b is provided, for example, between two rod sections 7a and enables the two rod sections 7a to relatively rotate. The joint sections 7b include motors. The rod sections 7a are relatively rotated by the joint sections 7b, whereby the robot arm 7 extends and contracts and can rotate 360 degrees.

A attracting section 7c is provided at the distal end portion of the robot arm 7. The robot arm 7 attracts the article P by sucking the article P with the attracting section 7c to attract the article P and grip the article P. The gripping of the article P in the robot arm 7 is not limited to the attraction. For example, the robot arm 7 may grab and grip the article P. The robot arm 7 may scoop to grip the article P.

In the storage 2, the article P hard to grip (grab) with the robot arm 7 depending on the shape of the article P, the exterior member material of the article P, and the like is sometimes safekept. Thus, the packaging apparatus 4 according to the embodiment packages at least a part of the articles P at a stage before being safekept in the storage 2 such that the articles P are easily gripped by the robot arm 7. Accordingly, the article P is safekept in the storage 2 in a state of being easily gripped by the robot arm 7.

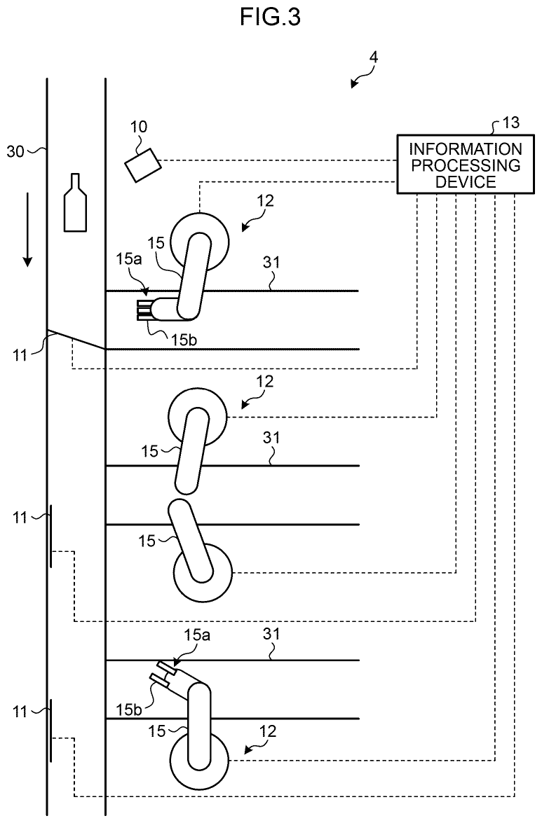

Subsequently, the packaging apparatus 4 is explained with reference to FIG. 3. FIG. 3 is a diagram illustrating an overview of the packaging apparatus 4. The packaging apparatus 4 includes a camera 10, a sorting unit 11, a packaging unit 12, and an information processing device 13.

The camera 10 images an article conveyed by a conveying unit 30. The camera 10 includes an imaging element such as a CCD (Charge Coupled Device) or a CMOS (Complementary Metal Oxide Semiconductor) and a lens. Image data of an article captured and acquired by the camera 10 is transmitted to the information processing device 13. The conveying unit 30 is, for example, a belt conveyor or a roller belt.

The sorting unit 11 sorts a specific article out of the articles P. The specific article is an article unsuitable for being grabbed by the robot arm 7 of the conveying unit 30 provided near the conveying unit 30. The specific article is an article hard to suck and grab with the attracting section 7c. For example, the specific article is an article hard to hold with suction because of the shape of the article P, the material of an exterior member of the specific article, and the like. Specifically, the specific article is an article where a shape of the article P does not have a flat surface that can be sucked or an article where a material of an exterior member of the article P is not a material that can be sucked. The specific article is determined depending on a method of gripping the article P in the robot arm 7.

The sorting unit 11 conveys the specific article to a packaging lane 31 out of the articles P conveyed in the conveying unit 30. For example, the sorting unit 11 is a change plate or a change rod that changes a conveying direction of the article P conveyed in the conveying unit 30. The sorting unit 11 is, for example, turnably provided. When conveying the specific article to the packaging lane 31, the sorting unit 11 turns from an initial position to a predetermined turning position and changes the conveying direction of the article P conveyed in the conveying unit 30.

A plurality of sorting units 11 are provided. A plurality of packaging lanes 31 are provided. The sorting units 11 are provided depending on the number of packaging lanes 31. For example, when there are three packaging lanes 31, three sorting units 11 are provided. The sorting units 11 sort specific articles to the packaging lanes 31 depending on characteristics of the specific articles. The characteristics of the specific articles include at least one of the shapes of the specific articles and the materials of the exterior members of the specific articles. The characteristics of the specific articles may include contents of the specific articles. In the packaging lanes 31, conveying units such as belt conveyor may be provided. Note that, as explained in detail below, the sorting units 11 are controlled by the information processing device 13 to operate.

The packaging unit 12 includes a plurality of packaging robot arms 15. The packaging robot arms 15 are provided depending on the packaging lanes 31. The number of packaging robot arms 15 provided in the packaging lanes 31 is set depending on a packaging method for packaging the specific articles. The packaging unit 12 changes a packaging method depending on the characteristics of the specific articles and packages the specific articles.

The packaging robot arm 15 has the same configuration as the configuration of the robot arm 7 of the conveying unit 30. A gripping unit 15a is provided at the distal end portion of the packaging robot arm 15. The gripping unit 15a includes a plurality of fingers 15b. The packaging robot arm 15 can, for example, lift an article with the plurality of fingers 15b. The packaging robot arm 15 can package the specific article with the plurality of fingers 15b.

The number of gripping units 15a, for example, the fingers 15b, the shapes of the fingers 15b, and the like are set depending on the packaging lanes 31. That is, the gripping unit 15a is set depending on a packaging method for packaging the specific article.

The packaging method for the specific article includes, for example, first packaging, second packaging, and third packaging. In the first packaging, taping is applied to the specific article. The taping is a string-like member having a part that can be sucked by the attracting section 7c of the robot arm 7 of the shipping unit 3. Note that the attracting section 7c of the robot arm 7 of the shipping unit 3 may be capable of attracting the string-like member.

In the second packaging, the specific article is compressed and wrapped. A wrapping member is a member that can be attracted by the attracting section 7c of the robot arm 7 of the shipping unit 3.

In the third packaging, the specific article is wrapped. As in the second packaging, a wrapping member is a member that can be attracted by the attracting section 7c of the robot arm 7 of the shipping unit 3.

The plurality of packaging robot arms 15 are robots capable of executing the first packaging to the third packaging. The packaging method for the specific article may be any one of the first packaging to the third packaging. The packaging method for the specific article includes at least one of the first packaging to the third packaging. The packaging method for the specific article is not limited to the method explained above.

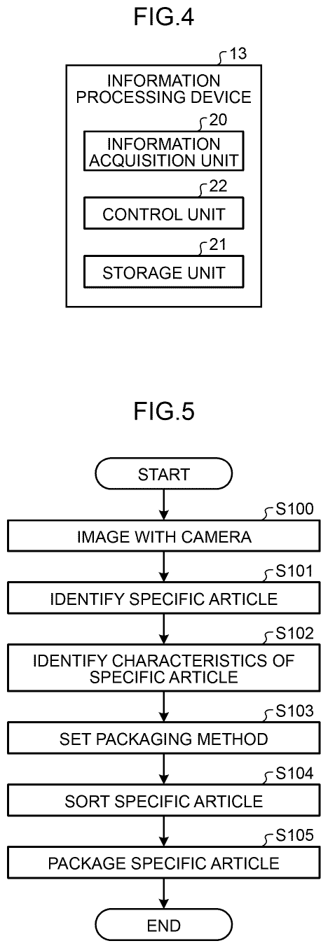

The information processing device 13 is explained with reference to FIG. 4. FIG. 4 is a control system block diagram of the information processing device 13. The information processing device 13 includes an information acquisition unit 20, a storage unit 21, and a control unit 22. The information processing device 13 is an identification unit that identifies a specific article.

The information acquisition unit 20 acquires image data of the article P captured and obtained by the camera 10. The information acquisition unit 20 outputs the acquired image data to the control unit 22.

The storage unit 21 is implemented by, for example, a storage medium such as a semiconductor memory element such as a RAM (Random Access Memory) or a flash memory. The storage unit 21 stores various programs and the like to be executed by the control unit 22.

The control unit 22 controls the camera 10, the sorting unit 11, and the packaging unit 12. The control unit 22 causes the camera 10 to operate. The control unit 22 causes the sorting unit 11 to operate. The information processing device 13 causes the packaging robot arms 15 to operate.

The control unit 22 identifies whether or not an article is a specific article. The control unit 22 identifies the specific article based on image data of the article P captured and obtained by the camera 10. The control unit 22 identifies the specific article by performing predetermined image processing on the image data of the article. For example, the control unit 22 identifies the specific article with pattern matching. Note that the predetermined image processing is not limited to the pattern matching.

The control unit 22 identifies characteristics of the specific article. The control unit 22 identifies the characteristic of the specific article by performing the predetermined image processing. Image processing for identifying the specific article and image processing for identifying the characteristics of the specific article may be the same kind of image processing or may be different kinds of image processing.

Note that the control unit 22 identifies the specific article and the characteristics of the specific article based on the image data of the article P obtained by the camera 10 but is not limited thereto. The specific article and the characteristics of the specific article may be identified using a sensor or the like.

When the article is the specific article, the control unit 22 sets a packaging method for the specific article depending on the characteristics of the specific article. The control unit 22 sets a packaging method for an article out of the first packaging to the third packaging depending on the characteristics of the specific article. Specifically, the control unit 22 sets an operation of the sorting unit 11 depending on the characteristics of the specific article.

For example, when the packaging method for the specific article is set to the first packaging based on the characteristics of the specific article, the control unit 22 controls the sorting unit 11 such that the specific article is conveyed to the packaging lane 31 in which the packaging robot arm 15 that executes the first packaging is provided.

The control unit 22 controls the packaging robot arm 15 to package the specific article conveyed to the packaging lane 31 with the set packaging method. For example, when the packaging method for the specific article is set to the first packaging, the control unit 22 controls the packaging robot arm 15 such that taping is applied to the specific article distributed to the packaging lane 31 in which the packaging robot arm 15 that executes the first packaging is provided.

The specific article packaged by the packaging robot arm 15 is stored in the commodity box 5 and stored in the storage 2.

Subsequently, the packaging processing according to the first embodiment is explained with reference to FIG. 5. FIG. 5 is a flowchart for explaining the packaging processing according to the first embodiment.

The information processing device 13 images an article with the camera 10 (S100). The information processing device 13 identifies a specific article based on image data of the article captured and obtained by the camera 10 (S101). The information processing device 13 identifies characteristics of the specific article (S102).

The information processing device 13 sets a packaging method for the identified specific article (S103). Specifically, the information processing device 13 sets a packaging method based on the identified characteristics of the specific article.

The information processing device 13 sorts the specific article (S104). Specifically, the information processing device 13 controls the sorting unit 11 such that the specific article is conveyed to the packaging lane 31 in which the packaging robot arm 15 that executes the set packaging method is provided.

The information processing device 13 packages the specific article conveyed to the packaging lane 31 (S105). The information processing device 13 controls the packaging robot arm 15 to package the specific article with the set packaging method.

The packaging apparatus 4 includes the information processing device 13 and the packaging unit 12. The information processing device 13 identifies whether or not an article is a specific article unsuitable for being grabbed by the robot arm 7. When the article is a specific article, the packaging unit 12 packages the article such that the specific article can be grabbed by the robot arm 7.

Accordingly, when the article is shipped from the storage 2 based on delivery information, the packaging apparatus 4 can cause the robot arm 7 to easily hold the article. For that reason, in the distribution center 1, the efficiency of shipping work for the article can be improved.

The packaging unit 12 changes a packaging method for the specific article depending on at least one of the shape of the specific article and the material of an exterior member of the specific article.

Accordingly, the packaging apparatus 4 can perform packaging corresponding to the specific article. For that reason, the packaging apparatus 4 can cause the robot arm 7 to easily hold the article.

The robot arm 7 provided in the shipping unit 3 includes the attracting section 7c and attracts the article with the attracting section 7c to grab the article.

The packaging apparatus 4 packages the specific article such that the article can be easily grabbed by the robot arm 7 that grabs the article with suction. For that reason, in the shipping unit 3 of the distribution center 1, a moving time of the article from the commodity box 5 to the delivery box 6 can be reduced. That is, the distribution center 1 can reduce a time required for shipping the article.

The packaging apparatus 4 may not include the sorting unit 11 and the plurality of packaging lanes 31 and may package the specific article conveyed by the conveying unit 30 with a set packaging method. For example, a plurality of packaging robot arms 15 are provided along the conveying unit 30 and the specific article is packaged by a packaging method corresponding to characteristics of the specific article. The packaging apparatus 4 may convey the specific article to one packaging lane 31 and package the specific article with the set packaging method.

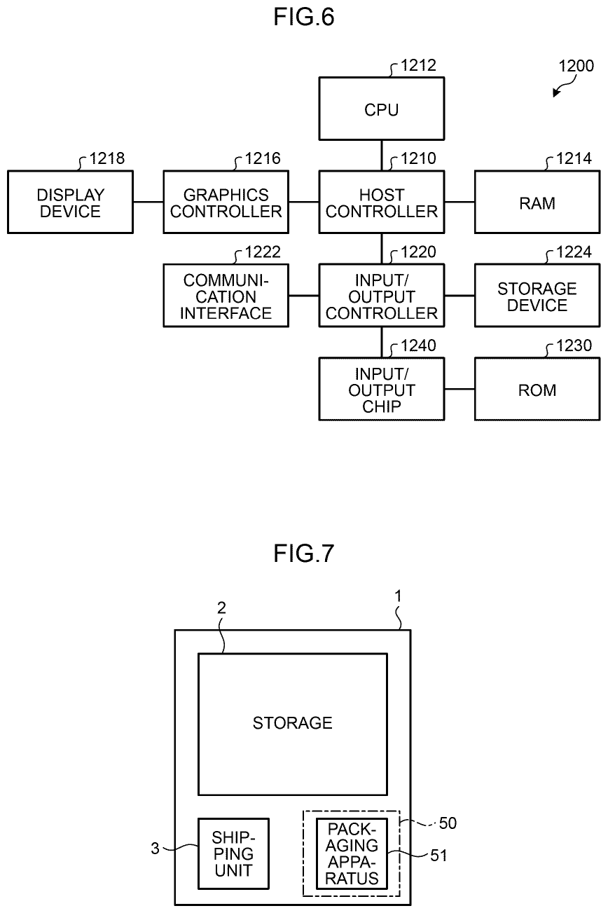

FIG. 6 is a diagram schematically illustrating an example of a hardware configuration of a computer 1200 functioning as the information processing device 13. A program installed in the computer 1200 can cause the computer 1200 to function as one or a plurality of “units” of the apparatus according to the present embodiment or cause the computer 1200 to execute an operation correlated with the apparatus according to the present embodiment or one or a plurality of “units” of the apparatus and/or cause the computer 1200 to execute a process according to the present embodiment or stages of the process. The program explained above may be executed by a CPU 1212 to cause the computer 1200 in order to execute specific operations correlated with some or all of flowcharts and blocks of block diagrams described in the present specification.

The computer 1200 according to the present embodiment includes the CPU 1212, a RAM 1214, and a graphics controller 1216 that are connected to one another by a host controller 1210. The computer 1200 also includes input/output units such as a communication interface 1222, a storage device 1224, a DVD drive, and an IC card drive that are connected to the host controller 1210 via an input/output controller 1220. The DVD drive may be a DVD-ROM drive, a DVD-RAM drive, or the like. The storage device 1224 may be a hard disk drive, a solid state drive, and the like. The computer 1200 also includes an input/output unit such as a ROM 1230 and a keyboard that are connected to the input/output controller 1220 via an input/output chip 1240.

The CPU 1212 operates according to programs stored in the ROM 1230 and the RAM 1214 to thereby control units. The graphics controller 1216 acquires image data generated by the CPU 1212 in a frame buffer or the like provided in the RAM 1214 or the RAM 1214 itself such that the image data is displayed on a display device 1218.

The communication interface 1222 communicates with other electronic devices via a network. The storage device 1224 stores programs and data to be used by the CPU 1212 in the computer 1200. The DVD drive reads a program or data from a DVD-ROM or the like and provides the program or the data to the storage device 1224. The IC card drive reads a program and data from an IC card and/or writes a program and data in the IC card.

The ROM 1230 stores therein a boot program or the like to be executed by the computer 1200 at the time of activation and/or a program dependent on hardware of the computer 1200. The input/output chip 1240 may also connect various input/output units to the input/output controller 1220 via a USB port, a parallel port, a serial port, a keyboard port, a mouse port, or the like.

Programs are provided by a computer-readable storage medium such as a DVD-ROM or an IC card. The programs are read from the computer-readable storage medium, installed in the storage device 1224, the RAM 1214, or the ROM 1230 that is also an example of the computer-readable storage medium, and executed by the CPU 1212. Information processing described in these programs is read by the computer 1200 and provides cooperation between the programs and various types of hardware resources. An apparatus or a method may be configured by implementing an operation or processing of information according to use of the computer 1200.

For example, when communication is executed between the computer 1200 and an external device, the CPU 1212 may execute a communication program loaded in the RAM 1214 and instruct, based on processing described in the communication program, the communication interface 1222 to perform communication processing. Under the control of the CPU 1212, the communication interface 1222 reads transmission data stored in a transmission buffer area provided in a recording medium such as the RAM 1214, the storage device 1224, the DVD-ROM, or the IC card, transmits the read transmission data to the network, or writes reception data received from the network in a reception buffer area or the like provided on the recording medium.

The CPU 1212 may allow the entirety or a necessary portion of a file or a database stored in an external recording medium such as the storage device 1224, the DVD drive (the DVD-ROM), or the IC card to be read in the RAM 1214 and may execute various types of processing on data on the RAM 1214. Subsequently, the CPU 1212 may write back the processed data in the external recording medium.

Various types of information such as various types of programs, data, tables, and databases may be stored in a recording medium and subjected to information processing. The CPU 1212 may execute, on data read from the RAM 1214, various types of processing including various types of operations, information processing, condition determination, conditional branching, unconditional branching, and information retrieval/replacement that are described everywhere in the present disclosure and designated by an instruction sequence of a program and writes back results in the RAM 1214. The CPU 1212 may retrieve information in the file, the database, or the like in the recording medium. For example, when a plurality of entries each having an attribute value of a first attribute correlated with an attribute value of a second attribute are stored in the recording medium, the CPU 1212 may retrieve an entry having the attribute value of the first attribute matching a designated condition out of the plurality of entries and read the attribute value of the second attribute stored in the entry to thereby acquire the attribute value of the second attribute correlated with the first attribute satisfying a predetermined condition.

The programs or the software modules explained above may be stored in a computer-readable storage medium on the computer 1200 or near the computer 1200. A recording medium such as a hard disk or a RAM provided in a server system connected to a dedicated communication network or the Internet can be used as the computer-readable storage medium, whereby a program is provided to the computer 1200 via the network.

The flowcharts and the blocks in the block diagrams in this embodiment may represent stages of processes in which operations are executed or “units” of an apparatus having a role of executing the operations. Specific stages and “units” may be implemented by a dedicated circuit, a programmable circuitry supplied together with a computer-readable instruction stored on the computer-readable storage medium, and/or a processor supplied together with a computer-readable instruction stored on the computer-readable storage medium. The dedicated circuit may include a digital and/or analog hardware circuit and may include an integrated circuit (IC) and/or a discrete circuit. The programmable circuit may include a reconfigurable hardware circuit, including AND, OR, exclusive OR, NAND, NOR, and other logical operations, a flip-flop, a register, and a memory element, such as a field programmable gate array (FPGA) and a programmable logic array (PLA).

The computer-readable storage medium may include any tangible device capable of storing instructions to be executed by an appropriate device. As a result, the computer-readable storage medium having instructions stored thereon includes a product including instructions that can be executed to create means for executing operations designated by the flowcharts or the block diagrams. Examples of the computer-readable storage medium may include an electronic storage medium, a magnetic storage medium, an optical storage medium, an electromagnetic storage medium, and a semiconductor storage medium. More specific examples of the computer-readable storage medium may include a floppy (registered trademark) disk, a diskette, a hard disk, a random access memory (RAM), a read-only memory (ROM), an erasable programmable read-only memory (EPROM or a flash memory), an electrically erasable programmable read-only memory (EEPROM), a static random access memory (SRAM), a compact disc read-only memory (CD-ROM), a digital versatile disk (DVD), a Blu-Ray (registered trademark) disc, a memory stick, and an integrated circuit card.

The computer-readable instruction may include any one of an assembler instruction, an instruction-set-architecture (ISA) instruction, a machine instruction, a machine-dependent instruction a microcode, a firmware instruction, or state-setting data and a source code or an object code described in any combination of one or a plurality of programming languages including an object oriented programming language such as Smalltalk (registered trademark), JAVA (registered trademark), or C++ and a conventional procedural programming language such as a “C” programming language or a similar programming language.

The computer readable instruction may be provided to a processor of a general purpose computer, a special purpose computer, or another programmable data processing device or a programmable circuit locally or via a local area network (LAN) or a wide area network (WAN) such as the Internet in order for the processor or the programmable circuit of the general purpose computer, the special purpose computer, or the other programmable data processing device to execute the computer-readable instruction in order to generate means for executing the operations designated by the flowcharts or the block diagrams. Examples of the processor include a computer processor, a processing unit, a microprocessor, a digital signal processor, a controller, and a microcontroller.

### Second Embodiment

Subsequently, a second embodiment is explained. Here, differences from the first embodiment are mainly explained. Explanation of the similarities to the first embodiment is omitted. For example, as illustrated in FIG. 7, a packaging system 50 and a packaging apparatus 51 according to the second embodiment are provided in the distribution center 1. FIG. 7 is a block diagram illustrating an overview of the distribution center 1.

The distribution center 1 includes the storage 2, the shipping unit 3, and the packaging system 50. The packaging system 50 includes the packaging apparatus 51.

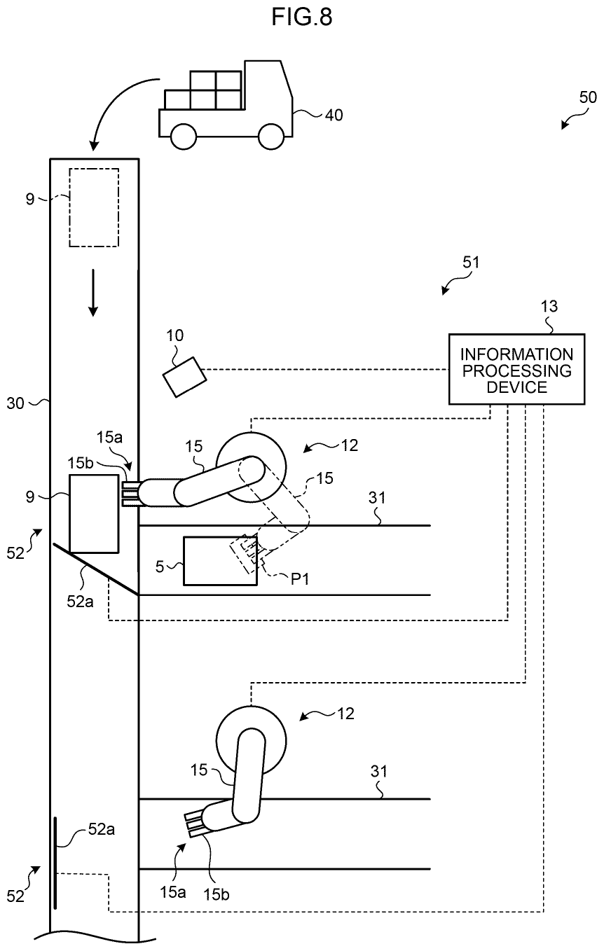

Subsequently, the packaging system 50 and the packaging apparatus 51 are explained with reference to FIG. 8. FIG. 8 is a diagram illustrating an overview the packaging system 50 and the packaging apparatus 51. As illustrated in FIG. 8, the packaging system 50 includes the packaging apparatus 51 and the conveying unit 30.

The packaging apparatus 51 includes the camera 10, a sorting unit 52, the packaging unit 12, and the information processing device 13. The camera 10 images a reception box 9 and an article conveyed by the conveying unit 30.

The sorting unit 52 sorts a specific article (an article P1 illustrated in FIG. 8) from articles P stored in the reception box 9 (for example, a cardboard box).

The sorting unit 52 moves the specific article to the packaging lane 31 out of the articles P stored in the reception box 9 conveyed in the conveying unit 30. In the sorting unit 52, the specific article is moved from the reception box 9 to the packaging lane 31 by the packaging robot arm 15. The sorting unit 52 includes a stop member 52a that stops the reception box 9 at a position where the specific article is sorted by the packaging robot arm 15 on a conveyance surface of the conveying unit 30. The stop member 52a is, for example, a plate-shaped member or a bar-shaped member that blocks the reception box 9 conveyed by the conveying unit 30.

The stop member 52a includes, for example, a turning shaft (not illustrated) and is provided to be turnable centering on the turning shaft along the conveyance surface of the conveying unit 30. When stopping the reception box 9, the stop member 52a turns from an initial position to a predetermined turning position. That is, the stop member 52a stops the reception box 9 by changing to a state of intersecting a conveying direction of the reception box 9. The stop member 52a allows the reception box 9 to pass by changing to a state of being substantially parallel to the conveying direction of the reception box 9. The passed reception box 9 is conveyed further to the downstream side in the conveying direction.

The sorting unit 52 includes the packaging lane 31. The packaging lane 31 is a lane branching from the conveying unit 30 and is, for example, a lane extending in a direction orthogonal to the conveying direction of the reception box 9 with respect to the conveying unit 30.

A plurality of sorting units 52 are provided. In this case, the plurality of the packaging lanes 31 are provided depending on the number of sorting units 52. In the plurality of packaging lanes 31, packaging methods are different from one another. The sorting unit 52 is provided to correspond to each of the plurality of packaging lanes 31. The sorting unit 52 moves a specific article to the packaging lane 31 corresponding to the sorting unit 52.

In the sorting unit 52, the specific article is moved to the packaging lane 31 by the packaging robot arm 15 depending on characteristics of the specific article in the reception box 9. In the packaging lane 31, for example, a box (for example, the commodity box 5) different from the reception box 9 that stores the specific article gripped by the packaging robot arm 15 may be prepared.

The conveying unit 30 conveys the reception box 9 storing at least one article P. The conveying unit 30 directly receives, from a transport vehicle 40 such as a truck, the reception box 9 transported by the transport vehicle 40. That is, the conveying unit 30 directly conveys the reception box 9 unloaded from the transport vehicle 40.

The control unit 22 of the information processing device 13 according to the second embodiment controls the camera 10, the sorting unit 52, and the packaging unit 12. The control unit 22 causes the sorting unit 52 to operate.

For example, when the shape of the article P does not have a flat surface that can be sucked, the control unit 22 identifies the article P as a specific article. For example, when the material of the exterior member of the article P is not a material that can be sucked, the control unit 22 identifies the article P as a specific article.

When the article P stored in the reception box 9 is identified as a specific article, the control unit 22 identifies characteristics of the specific article.

When the article P stored in the reception box 9 is the specific article, the control unit 22 sets a packaging method for the specific article depending on the characteristics of the specific article. The control unit 22 sets the packaging method of the article P out of first packaging to third packaging depending on the characteristics of the specific article. Specifically, when the shape of the article P does not have a flat surface that can be sucked, the control unit 22 sets the second packaging as the packaging method for the article P. When the shape of the article P is a box shape and the material of the exterior member of the article P is not a material that can be sucked, the control unit 22 sets the first packaging as the packaging direction of the article P. When the shape of the article P has a flat surface that can be sucked but is not a box shape and the material of the exterior member of the article P is not a material that can be sucked, the control unit 22 sets the third packaging as the packaging method.

The control unit 22 sets an operation of the sorting unit 52 depending on the characteristics of the specific article. For example, when the packaging method for the specific article is set to the first packaging based on the characteristics of the specific article, the control unit 22 controls the stop member 52a of the sorting unit 52 such that the reception box 9 stops at a sorting position of the packaging robot arm 15 that executes the first packaging.

The control unit 22 controls the packaging robot arm 15 to package, with the set packaging method, the specific article taken out from the reception box 9. For example, when the packaging method for the specific article is set to the first packaging, the control unit 22 controls the packaging robot arm 15 such that taping is applied to the specific article taken out from the reception box 9 by the packaging robot arm 15 that executes the first packaging.

The specific article packaged by the packaging robot arm 15 is stored in the commodity box 5 and stored in the storage 2. In addition, the specific article packaged by the packaging robot arm 15 may be stored, by the packaging robot arm 15, in the commodity box 5 or the like prepared in the packaging lane 31 and may be moved to the storage 2 together with the commodity box 5, for example, when the commodity box 5 is filled.

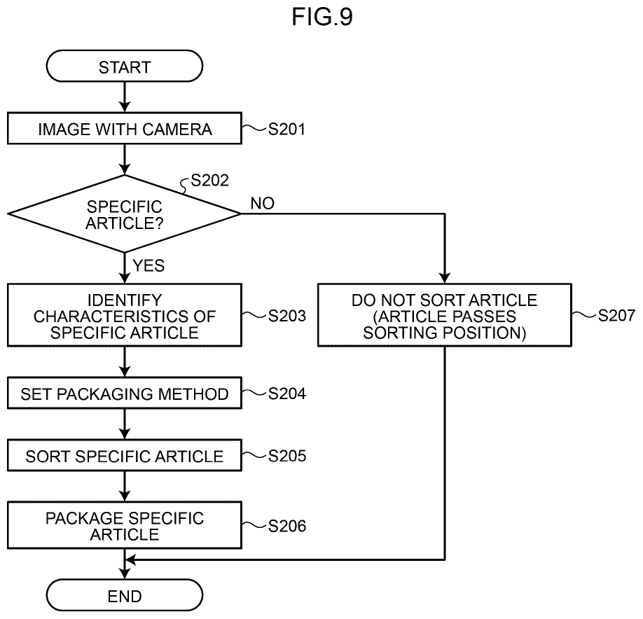

Subsequently, packaging processing according to the second embodiment is explained with reference to FIG. 9. FIG. 9 is a flowchart for explaining the packaging processing according to the second embodiment.

The information processing device 13 images the article P stored in the reception box 9 with the camera 10 (Step S201). The information processing device 13 identifies, based on image data of the article P captured and obtained by the camera 10, whether or not the article P is a specific article (Step S202). Note that, when a plurality of articles P is stored in the reception box 9, for example, only one article P among the plurality of articles P stored in the reception box 9 is a specific article in some cases and two or more articles P among the plurality of articles P are specific articles in other cases.

When the information processing device 13 identifies the article P as the specific article (Step S202: Yes), the information processing device 13 identifies characteristics of the specific article (Step S203).

The information processing device 13 sets a packaging method for the identified specific article (Step S204). Specifically, the information processing device 13 sets a packaging method based on the identified characteristics of the specific article.

The information processing device 13 sorts the specific article (Step S205). Specifically, the information processing device 13 controls the sorting unit 52 such that the reception box 9 stops at the sorting position where the packaging robot arm 15 that executes the set packaging method is provided. Then, the information processing device 13 controls the packaging robot arm 15 to take out the specific article from the reception box 9.

The information processing device 13 packages the specific article taken out from the reception box 9 (Step S206). The information processing device 13 controls the packaging robot arm 15 to package the specific article with the set packaging method. When the article P is identified as not a specific article in the processing in Step S202 (Step S202: No), the information processing device 13 does not sort the article P (Step S207). The information processing device 13 controls the sorting unit 52 not to sort the article P. Accordingly, the article P passes the sorting position.

Note that, when the packaging method for the specific article includes the first packaging, the second packaging, and the third packaging explained above, for example, when two or more among the first packaging to the third packaging are mixed in the articles P stored in the reception box 9, the information processing device 13 conveys, in order, the reception box 9 to positions of sorting by the packaging robot arm 15 corresponding to the respective types of packaging.

As explained above, the packaging apparatus 51 according to the embodiment includes the information processing device 13 and the packaging unit 12. The information processing device 13 identifies whether or not at least one article P stored in the reception box 9 is a specific article unsuitable for the robot arm 7 to grab. When the article P is the specific article, the packaging unit 12 takes out an article (the article P1) that is a specific article from the reception box 9 and packages the article (the article P1) taken out from the reception box 9 such that the robot arm 7 can grab the specific article.

With the configuration explained above, the packaging apparatus 51 can cause the robot arm 7 to easily grab the article P when the article P is shipped from the storage 2 based on delivery information. For that reason, in the distribution center 1, the efficiency of shipping work for the article P can be improved. When the specific article is packaged, the specific article is identified from the articles P stored in the reception box 9 and the article P (the article P1) is directly taken out from the reception box 9 and packaged. Therefore, for example, it is possible to save time and effort for identifying whether or not each article P is a specific article and packaging the article P. Accordingly, the packaging work can be simplified.

In the packaging apparatus 51 according to the embodiment, the packaging unit 12 changes the packaging method for the specific article depending on at least one of the shape of the specific article and the material of the exterior member of the specific article.

With the configuration explained above, the packaging apparatus 51 can perform packaging corresponding to the specific article. For that reason, the packaging apparatus 51 can cause the robot arm 7 to easily hold the article P.

Furthermore, in the packaging apparatus 51 according to the embodiment, the robot arm 7 provided in the shipping unit 3 includes the attracting section 7c and attracts an article with the attracting section 7c to grab the article.

With configuration explained above, the specific article is packaged such that the article P can be easily grabbed by the robot arm 7 that grabs the article P with suction. For that reason, in the shipping unit 3 of the distribution center 1, a moving time of the article P from the commodity box 5 to the delivery box 6 can be reduced. That is, the distribution center 1 can reduce a time required for shipping the article P.

The packaging system 50 according to the embodiment includes the packaging apparatus 51 and the conveying unit 30. The packaging apparatus 51 includes the information processing device 13 and the packaging unit 12. The information processing device 13 identifies whether or not at least one article P stored in the reception box 9 is a specific article unsuitable for the robot arm 7 to grab. When the article P is a specific article, the packaging unit 12 takes out the article P (the article P1) that is the specific article from the reception box 9 and packages the article P (the article P1) taken out from the reception box 9 such that the robot arm 7 can grab the specific article. The conveying unit 30 conveys the reception box 9. The conveying unit 30 directly coveys the reception box 9 unloaded from the transport vehicle 40 that transports the reception box 9. The information processing device 13 identifies whether or not the article P stored in the reception box 9 conveyed by the conveying unit 30 is a specific article.

With the configuration explained above, since the conveying unit 30 directly conveys the reception box 9 unloaded from the transport vehicle 40, that is, immediately conveys the reception box 9 unloaded from the transport vehicle 40, a time until the reception box 9 reaches a sorting position for the specific article can be reduced. Accordingly, a time required for the packaging work can be reduced.

Note that the packaging system 50 may include a plurality of conveying units 30 and include the packaging apparatus 51 in each of the conveying units 30. Since the conveying units 30 convey the reception box 9 as explained above, the time required for the packaging work can be further reduced.

In the packaging robot arm 15 of the packaging apparatus 51, one packaging robot arm 15 may correspond to two or more among the first packaging to the third packaging. Accordingly, the packaging system 50 can be simplified.

### Third Embodiment

Subsequently, a third embodiment is explained. Here, differences from the first embodiment are mainly explained. Explanation of the similarities to the first embodiment is omitted.

The packaging apparatus 4 according to the third embodiment is configured to be able to efficiently package the article P at the time of packaging the article P.

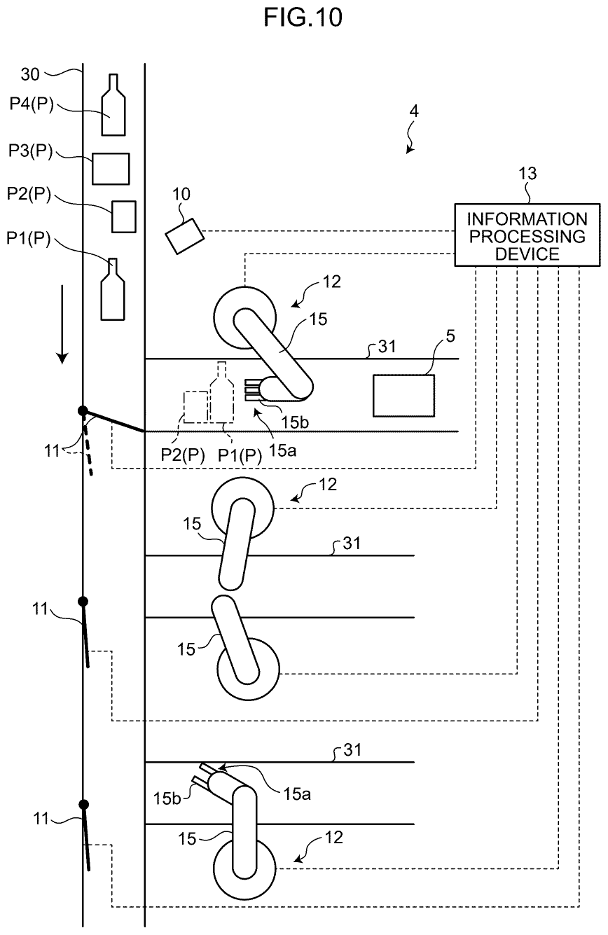

The packaging apparatus 4 according to the third embodiment is explained with reference to FIG. 10 and the like. FIG. 10 is a diagram illustrating an overview of the packaging apparatus 4.

The conveying unit 30 is, for example, a belt conveyor or a roller belt. A plurality of articles P are conveyed by the conveying unit 30. Specifically, the conveying unit 30 conveys the plurality of articles P to the storage 2 before being stored in the storage 2 (see FIG. 1). In FIG. 10, an example in which the number of articles P is four is illustrated for convenience of understanding. Hereinafter, the four articles P are sometimes described as “first article P1”, “second article P2”, “third article P3”, and “fourth article P4”. However, when the articles P are explained without being particularly distinguished, the articles P are described as “article P”. The first article P1 and the fourth article P4 are articles of the same type and the first and fourth articles P1 and P4, the second article P2, and the third article P3 are articles of types different from one another. In the example illustrated in FIG. 10, the first article P1, the second article P2, the third article P3, and the fourth article P4 are conveyed in this order but is not limited thereto. The number and the shape of the articles P illustrated in FIG. 10 are only examples and are not limiting.

The sorting unit 11 sorts specific articles out of the plurality of articles P. In the example illustrated in FIG. 10, it is assumed that the first article P1 and the fourth article P4 correspond to the specific articles.

The sorting unit 11 conveys the specific articles to the packaging lane 31 out of the plurality of articles P conveyed by the conveying unit 30. Here, since the first article P1 that is the specific article is conveyed to the sorting unit 11 first, the sorting unit 11 sorts the first article P1 first.

When the specific article (here, the first article P1) is conveyed to the packaging lane 31, the sorting unit 11 turns from an initial position to a predetermined turning position and changes a conveying direction of the specific article conveyed in the conveying unit 30.

When being in a state of the initial position indicated by a broken line, the sorting unit 11 does not change the conveying direction of the article P and allows the article P to pass. The passed article P is conveyed further to the downstream side in the conveying direction.

Besides the specific article, the sorting unit 11 also sorts the article P that can be bundled with the specific article. The article that can be bundled with the specific article (hereinafter sometimes described as “article that can be bundled”) is an article sold together with the specific article as a set, an article ordered together with the specific article, or the like. The article that can be bundled is selected out of a plurality of articles P conveyed by the conveying unit 30. Processing of selecting the article that can be bundled is executed by the information processing device 13. The processing is explained below. Note that, in the example illustrated in FIG. 10, it is assumed that the second article P2 corresponds to and selected as the article that can be bundled. The sorting unit 11 conveys the selected article that can be bundled (here, the second article P2) to the packaging lane 31.

In the packaging apparatus 4, a plurality of packaging lanes 31 are provided. In the plurality of packaging lanes 31, packaging methods are different from one another. The sorting unit 11 is provided to correspond to each of the plurality of packaging lanes 31. The sorting unit 11 moves a specific article and the like to the packaging lane 31 corresponding to the sorting unit 11.

When the specific article is packaged, the packaging unit 12 also packages together the article that can be bundled. That is, as indicated by an alternate long and two short dashes line in FIG. 10, the packaging unit 12 collectively packages the specific article (here, the first article P1) and the article that can be bundled (here, the second article P2). Specifically, the packaging unit 12 collectively packages the specific article and the article that can be bundled such that the specific article can be grabbed by the robot arm 7 (see FIG. 2). Since the packaging unit 12 according to the present embodiment packages together not only the specific article but also the article that can be bundled as explained above, it is possible to efficiently package the article (the specific article). Note that, when there is no article that can be bundled among the plurality of articles P, the packaging unit 12 packages only the specific article.

The packaging robot arm 15 that performs the packaging explained above can lift, for example, the article P (the specific article or the article that can be bundled) with the plurality of fingers 15b. The packaging robot arm 15 can package, with the plurality of fingers 15b, the specific article and the article that can be bundled.

In the packaging lane 31, a box (for example, the commodity box 5) for storing the specific article and the like packaged by the packaging robot arm 15 may be prepared. The packaging robot arm 15 stores the packaged specific article and the like in the commodity box 5. The commodity box 5 in which the packaged specific article and the like are stored is conveyed to the storage 2 (see FIG. 1) by a not-illustrated cart robot.

The information processing device 13 is explained. The information processing device 13 is a selection unit that selects an article that can be bundled.

The information acquisition unit 20 acquires order information included in delivery information. The information acquisition unit 20 acquires the order information from a device (for example, an external device such as a server) that receives an order for an article. However, the information acquisition unit 20 is not limited thereto and may acquire the order information from any device. The information acquisition unit 20 causes the storage unit 21 to store the acquired order information. Details of the order information are explained below with reference to FIG. 12.

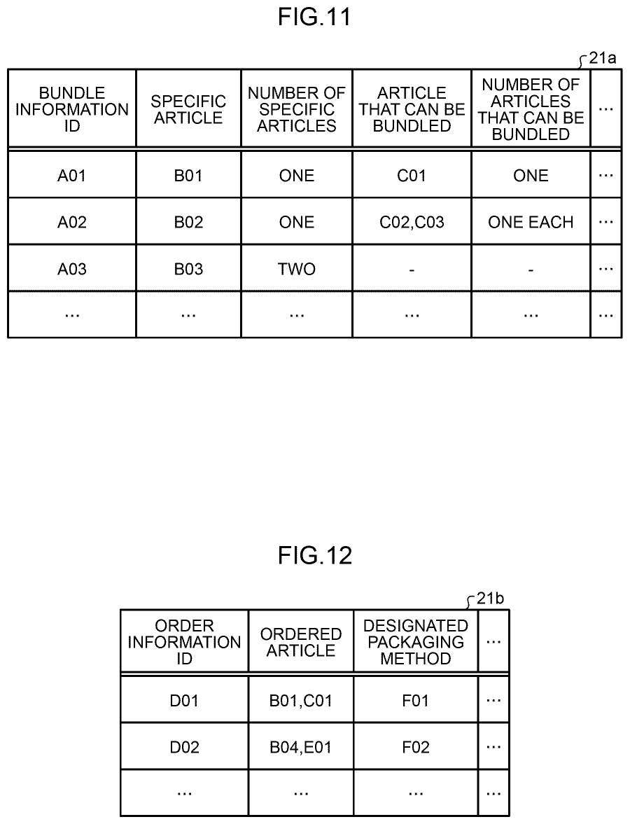

The storage unit 21 stores bundle information concerning an article to be bundled with a specific article and order information concerning an order for the article. First, the bundle information is explained with reference to FIG. 11. FIG. 11 is a diagram illustrating an example of bundle information 21a.

The bundle information 21a is predetermined information indicating an article that can be bundled depending on a type of a specific article. Specifically, as illustrated in FIG. 11, the bundle information 21a includes items such as “bundle information ID”, “specific article”, “number of specific articles”, “article that can be bundled”, and “number of articles that can be bundled”. Pieces of data of the items are correlated with (linked with) one another. Note that the bundle information 21a is information stored in the storage unit 21 in advance but is not limited thereto.

The “bundle information ID” is information for identifying the bundle information. The “specific article” is information indicating a type of the specific article. In other words, the “specific article” is information indicating a type of an article unsuitable for being grabbed by the robot arm 7. The “specific article” includes, for example, an article ID for identifying a specific article but is not limited thereto and may be, for example, information of a commodity name of an article. Note that, in the example illustrated in FIG. 11, for convenience, the “specific article” is described in an abstract manner as, for example, “B01”. However, specific information is assumed to be stored in “B01”. Hereinafter, other information is sometimes described in an abstract manner.

The “number of specific articles” is information indicating the number of specific articles to be packaged (bundled) together. Here, the number of specific articles packaged together by the packaging robot arm 15 is not limited to one and may be two or more. Specifically, in FIG. 10 referred to above, an example in which the article that can be bundled with the specific article is the article other than the specific article (specifically, the article of the type (the second article P2) different from the specific article) is explained but is not limited thereto. That is, some specific articles are sold in a set of a plurality of specific articles depending on a type of the articles. In such a case, the “number of specific articles” is set to a plurality of pieces. When the plurality of specific articles are bundled, the article (the second article P2) other than the specific articles is bundled in some cases and is not bundled in other cases.

The “article that can be bundled” is information indicating a type of an article that can be bundled with a specific article. Specifically, some specific articles are sold in a set with articles of different types. As an example, when the specific article is a toothbrush, the toothbrush is sometimes sold in a set with a toothpaste. As another example, when the specific article is a writing implement, the writing implement is sometimes sold in a set with a notebook. In the “article that can be bundled” according to the present embodiment, information concerning the article sold in a set with the specific article explained above is set. Note that the “article that can be bundled” corresponding to the specific article is not limited to one type and may be a plurality of types.

The “article that can be bundled” includes, for example, an article ID for identifying the article that can be bundled but is not limited thereto and may be information of a commodity name of the article.

The “number of articles that can be bundled” is information indicating the number of articles that can be packaged (bundled) together with the specific article. Note that, when a plurality of specific articles are bundled and articles (that is, articles that can be bundled) other than the specific articles are not bundled as described above, data is not registered in the “articles that can be bundled” and the “number of articles that can be bundled” of the bundle information 21a.

In the example illustrated in FIG. 11, bundle information identified by a bundle information ID “A01” indicates that a specific article is “B01”, the number of the specific articles is “1”, an article that can be bundled is “C01”, and the number of articles that can be bundled is “1” . Bundle information identified by a bundle information ID “A02” indicates that a specific article is “B02”, the number of specific articles is “one”, articles that can be bundled are “C02, C03”, and the number of articles that can be bundled is “one each”. That is, the bundle information with the bundle information ID “A02” indicates that there are two types of articles that can be bundled.

Bundle information identified by a bundle information ID “A03” indicates that a specific article is “B03”, the number of specific articles is “two”, and data of an article that can be bundled and the number of articles that can be bundled is not registered. That is, the bundle information with the bundle information ID “A03” indicates that a specific article “B03” is packaged and sold as a set of two pieces.

Subsequently, order information is explained with reference to FIG. 12. FIG. 12 is a diagram illustrating an example of order information 21b.

As illustrated in FIG. 12, the order information 21b includes items such as “order information ID”, “ordered article”, and “designated packaging method”, and data of the items are correlated with (linked with) one another.

The “order information ID” is information for identifying order information. The “ordered article” is information indicating a type of an article ordered by the user. The “ordered article” includes, for example, an article ID for identifying the ordered article but is not limited thereto and may be, for example, information concerning a product name of the article.

The “designated packaging method” is information concerning a packaging method for an ordered article designated by the user. Specifically, when wrapping is designated by the user, information concerning the designated wrapping is set in the “designated packaging method”. The “designated packaging method” includes information concerning wrapping for a gift such as wrapping for a birthday or Christmas. Here, the ordered article is packaged using the designated wrapping. However, when the ordered article includes a specific article, the ordered article (the specific article) is packaged, while using the designated wrapping, such that the ordered article can be grabbed by the robot arm 7.

In the example illustrated in FIG. 12, order information identified by an order information ID “D01” indicates that order information is “B01, C01” and a designated packaging method is “F01”. For example, when ordered articles “B01, C01” are a specific article and an article that can be bundled, the specific article and the article that can be bundled are packaged, while using wrapping designated by the designated packaging method “F1”, such that the specific article and the article that can be bundled can be grabbed by the robot arm 7.

Order information identified by an order information ID “D02” indicates that ordered articles are “B04, E01” and a designated packaging method is “F02”. Here, the ordered article “B04” is a specific article. The ordered article “E01” is an article that is neither a specific article and nor the “article that can be bundled” included in the bundle information 21a. In such a case, the specific article (B01) and the article (E01) ordered together with the specific article are packaged, while using wrapping designated by the designated packaging method “F02”, such that the specific article (B01) and the article (E01) can be grabbed by the robot arm 7. When a packaging method is not designated by the user, data is not registered in the “designated packaging method” and the specific article and the like are packaged by a normal packaging method (a packaging method with which an article can be grabbed by the robot arm 7).

The control unit 22 identifies whether or not an article is a specific article. Specifically, the control unit 22 identifies whether or not each of a plurality of articles is a specific article. More specifically, the control unit 22 identifies whether or not one article (an example of a predetermined article) among a plurality of articles is a specific article unsuitable for being grabbed by the robot arm 7. For example, the control unit 22 identifies whether or not one article (a predetermined article) among a plurality of articles conveyed by the conveying unit 30 is a specific article. The control unit 22 repeatedly executes identification processing explained above by the number of articles.

For example, the control unit 22 identifies a specific article based on image data of an article captured and obtained by the camera 10.

When identifying the article as the specific article, the control unit 22 identifies a type of the specific article. The control unit 22 performs predetermined image processing to identify the type of the specific article. Image processing for identifying a specific article and image processing for identifying a type of the specific article may be the same image processing or different kinds of image processing.

The control unit 22 identifies characteristics of the specific article. The control unit 22 identifies the characteristic of the specific article by performing the predetermined image processing. Image processing for identifying a specific article (or image processing for identifying a type of the specific article) and image processing for identifying characteristics of the specific article may be the same image processing or may be different kinds of image processing.

Note that the control unit 22 identifies the specific article and the characteristics of the specific article based on the image data of the article obtained by the camera 10 but is not limited thereto. The specific article and the characteristics of the specific article may be identified using a sensor or the like. For example, when a barcode added to an article is read by the camera 10 functioning as a barcode reader, for example, the control unit 22 may identify whether or not the article is a specific article, identify a type of the specific article, and identify characteristics of the specific article.

When the article (the predetermined article) is identified as the specific article, the control unit 22 selects, out of the plurality of articles, an article that can be bundled with the specific article. For example, the control unit 22 selects, based on the identified type of the specific article and the bundle information 21a, an article that can be bundled (see FIG. 11).

Specifically, when the “article that can be bundled” of the bundle information 21a is set for the identified type of the specific article, the control unit 22 selects, as the article that can be bundled with the specific article, an article (the second article P2 in the example illustrated in FIG. 10) set in the “article that can be bundled”. At this time, the control unit 22 also determines, based on the “number of articles that can be bundled” of the bundle information 21a, the number of selected articles that can be bundled.

When the specific article is a plurality of articles that can be collectively packaged, that is, when the “number of specific articles” is set to a plurality of pieces in the bundle information 21a, the control unit 22 selects, as an article that can be bundled, a specific article different from the identified specific article. As an example, when the “number of specific articles” of the bundle information 21a is set to two, the control unit 22 selects, as the article that can be bundled, a specific article (the fourth article P4 in the example illustrated in FIG. 10) different from the identified specific article (the first article P1 in the example illustrated in FIG. 10).

The control unit 22 may select, based on the order information 21b including the specific article, it as the article that can be bundled. When the specific article and an article other than the specific article are included in the “ordered article” of the order information 21b, the control unit 22 may select the article other than the specific article as the article that can be bundled. Here, the article other than the specific article is an article (the third article P3 in the example illustrated in FIG. 10) that is not the “article that can be bundled” included in the bundle information 21a but is not limited thereto.

Note that the control unit 22 may select, based on both of the bundle information 21a and the order information 21b, the article that can be included or may select, based on one of the bundle information 21a and the order information 21b, the article that can be included. That is, the control unit 22 may select, based on at least one of the bundle information 21a and the order information 21b, the article that can be bundled.

When the article is the specific article, the control unit 22 sets a packaging method for the specific article depending on the characteristics of the specific article. The control unit 22 sets a packaging method for an article out of the first packaging to the third packaging depending on the characteristics of the specific article. For example, when the shape of the article (the specific article) does not have a flat surface that can be sucked, the control unit 22 sets the second packaging as the packaging method for the article. When the shape of the article (the specific article) is a box shape and the material of an exterior member of the article is not a material that can be sucked, the control unit 22 sets the first packaging as the packaging method for the article. When the shape of the article (the specific article) is not a box shape although having a flat surface that can be sucked and the material of the exterior member of the article is not a material that can be sucked, the control unit 22 sets the third packaging as the packaging method.

Specifically, the control unit 22 sets an operation of the sorting unit 11 depending on the characteristics of the specific article. For example, when the packaging method for the specific article is set to the first packaging based on the characteristics of the specific article, the control unit 22 controls the sorting unit 11 such that the specific article and the article that can be bundled are conveyed to the packaging lane 31 in which the packaging robot arm 15 that executes the first packaging is provided.

The control unit 22 controls the packaging robot arm 15 such that the specific article and the article that can be bundled conveyed to the packaging lane 31 are packaged by the set packaging method. When the packaging method for the specific article is set to the first packaging, the control unit 22 controls the packaging robot arm 15 such that taping is applied to the specific article and the article that can be bundled distributed to the packaging lane 31 in which the packaging robot arm 15 that executes the first packaging is provided.

As explained above, the control unit 22 controls the packaging robot arm 15 that is the packaging unit 12 to collectively package the specific article and the article that can be bundled such that the specific article can be grabbed by the robot arm 7.

The control unit 22 may control the packaging robot arm 15 that is the packaging unit 12 to change a packaging method for the specific article depending on the order information 21b for the specific article (see FIG. 12).

For example, when the specific article and the article that can be bundled are included in the order information 21b and a packaging method is designated, the control unit 22 controls the packaging robot arm 15 that is the packaging unit 12, and while using the designated packaging method (for example, gift wrapping), packages the specific article and the article that can be bundled such that the specific article and the containable article can be grabbed by the robot arm 7.

The specific article and the article that can be bundled packaged by the packaging robot arm 15 are stored in the commodity box 5 and safekept in the storage 2. The specific article and the like packaged by the packaging robot arm 15 may be stored by the packaging robot arm 15 in the commodity box 5 or the like prepared in the packaging lane 31 and may be moved to the storage 2 together with the commodity box 5, for example, when the commodity box 5 is filled.

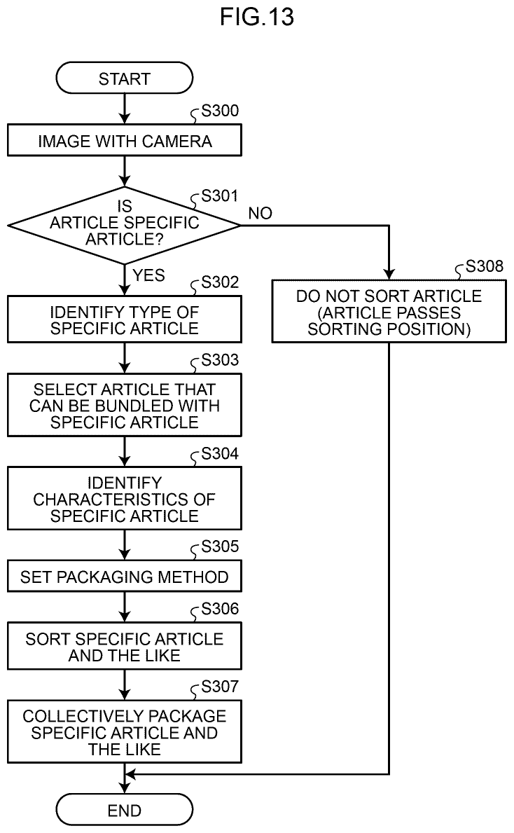

Subsequently, packaging processing according to the third embodiment is explained with reference to FIG. 13. FIG. 13 is a flowchart for explaining the packaging processing according to the third embodiment.

As illustrated in FIG. 13, the information processing device 13 images an article with the camera 10 (Step S300). The information processing device 13 identifies, based on image data of the article captured and obtained by the camera 10, whether or not the article is a specific article (Step S301). Precisely, the information processing device 13 identifies whether or not one article (a predetermined article) among a plurality of articles is a specific article. When the article is identified as a specific article (Step S301, Yes), the information processing device 13 identifies a type of the specific article (Step S302). Subsequently, the information processing device 13 selects, depending on the identified type of the specific article, an article that can be bundled with the specific article (Step S303). In the processing in Step S303, when the specific article is a plurality of articles that can be collectively packaged, a specific article different from the identified specific article may be selected as an article that can be bundled. In the processing in Step S303, when a specific article is included in the order information 21b, an article ordered together with the specific article may be selected as an article that can be bundled.

Subsequently, the information processing device 13 identifies characteristics of the specific article (Step S304). The information processing device 13 sets a packaging method for the identified specific article (Step S305). Specifically, the information processing device 13 sets a packaging method based on the identified characteristics of the specific article. In the processing in Step S305, when a packaging method is designated in the order information 21b, with reference to the order information 21b, the packaging method may be changed to the designated packaging method (for example, a packaging method using gift wrapping). Note that, like the packaging method before the change, the packaging method after the change is a packaging method with which an article can be grabbed by the robot arm 7.

The information processing device 13 sorts the specific article and the article that can be bundled (Step S306). Specifically, the information processing device 13 controls the sorting unit 11 such that the specific article and the article that can be bundled are conveyed to the packaging lane 31 in which the packaging robot arm 15 that executes the set packaging method is provided.

The information processing device 13 collectively packages the specific article and the article that can be bundled conveyed to the packaging lane 31 (Step S307). The information processing device 13 controls the packaging robot arm 15 to package, with the set packaging method, the specific article and the article that can be bundled.

On the other hand, when the article is identified as not a specific article (Step S301, No), the information processing device 13 does not sort the article (Step S308). That is, the information processing device 13 controls the sorting unit 11 not to sort the article. Accordingly, the articles pass a sorting position.

As explained above, the packaging apparatus 4 according to the present embodiment includes the information processing device 13 functioning as an identification unit and a selection unit and the packaging unit 12. The information processing device 13 identifies whether or not one predetermined article among a plurality of articles is a specific article unsuitable for being grabbed by the robot arm 7. When identifying the predetermined article as a specific article, the information processing device 13 selects an article that can be bundled with the specific article out of the plurality of articles. The packaging unit 12 collectively packages the specific article and the article that can be bundled such that the specific article can be grabbed by the robot arm 7.

Accordingly, when the article is shipped from the storage 2 based on delivery information, the packaging apparatus 4 can cause the robot arm 7 to easily hold the article. For that reason, in the distribution center 1, the efficiency of shipping work for the article can be improved. Since the packaging apparatus 4 packages together not only the specific article but also the article that can be bundled, it is possible to efficiently package the articles (the specific articles).

The specific article and the article that can be bundled are collectively packaged at a stage before being safekept in the storage 2. Therefore, for example, in the shipping unit 3 of the distribution center 1, when the specific article and the like are moved from the commodity box 5 to the delivery box 6, the robot arm 7 can easily grab the specific article and the article that can be bundled and collectively move the specific article and the article that can be bundled and reduce a moving time of the specific article and the like. That is, the distribution center 1 can reduce a time required for shipping the specific article and the like.

The information processing device 13 functioning as the selection unit selects, depending on a type of the specific article, an article that can be bundled.

Accordingly, the information processing device 13 can select, as the article that can be bundled, an article that matches the type of the specific article and, for example, is sold as a set with the specific article. For that reason, the packaging unit 12 can collectively package the specific article and the article sold as a set with the specific article (the article that can be bundled). Therefore, for example, the robot arm 7 can easily grab the article sold as a set with the specific article (the article that can be bundled) and can collectively move the specific article and the article that can be bundled and reduce a moving time of the specific article and the like. That is, the distribution center 1 can reduce a time required for shipping the specific article and the like.

The information processing device 13 functioning as the selection unit selects, based on at least one of the predetermined bundle information 21a indicating the article that can be bundled depending on the type of the specific article and the order information 21b including the specific article, the article that can be bundled.

Accordingly, by using the predetermined bundle information 21a, the information processing device 13 is capable of accurately selecting, as the article that can be bundled, an article matching the type of article. By using the order information 21b including the specific article, the information processing device 13 is capable of selecting, as the article that can be bundled, an article ordered together with the specific article. For that reason, the packaging unit 12 can collectively package the specific article and the selected article that can be bundled. Therefore, for example, the robot arm 7 can easily grab the specific article and the article that can be bundled and collectively move the specific article and the article that can be bundled and can reduce a moving time of the specific article and the like. That is, the distribution center 1 can reduce a time required for shipping the specific article and the like.

When the specific article is a plurality of articles that can be collectively packaged, the information processing device 13 functioning as the selection unit selects a specific article different from the identified specific article as an article that can be bundled. The packaging unit 12 collectively packages the plurality of specific articles, more specifically, packages the plurality of specific articles such that the specific articles can be grabbed by the robot arm 7.

Accordingly, the packaging unit 12 can collectively package a plurality of specific articles sold as a set. For that reason, for example, the robot arm 7 can easily grab the plurality of specific articles sold as a set and collectively move the specific articles and can reduce a moving time of the specific article and the like. That is, the distribution center 1 can reduce a time required for shipping the plurality of specific articles sold as a set.

The packaging unit 12 changes a packaging method for the specific article depending on order information for the specific article.

Accordingly, the packaging unit 12 can package the specific article with a packaging method corresponding to the order information. The specific article and the like packaged by the packaging method are stored in the storage 2. For that reason, for example, in the shipping unit 3 of the distribution center 1, when the specific article and the like are moved from the commodity box 5 to the delivery box 6, the robot arm 7 can directly grab and move the specific article and the like because the specific article and the like have already been packaged by the packaging method corresponding to the order information. That is, since it is unnecessary for the shipping unit 3 to package the specific article with the packaging method corresponding to the order information, it is possible to ship the specific article and the like earlier.

The packaging unit 12 changes the packaging method for the specific article depending on at least one of the shape of the specific article and the material of the exterior member of the specific article.

Accordingly, the packaging apparatus 4 can perform packaging corresponding to the specific article. For that reason, the packaging apparatus 4 can cause the robot arm 7 to easily hold the article.

The information processing device 13 functioning as the identification unit identifies whether or not one predetermined article among a plurality of articles conveyed by the conveying unit 30 is a specific article.

Accordingly, the information processing device 13 is capable of executing the identification processing for the specific article while causing the conveying unit 30 to convey the article, for example, at a stage before the specific article is stored in the storage 2. For that reason, the information processing device 13 can identify the article (in other words, the article before being stored in the storage 2) as a specific article as early as possible and, as a result, the packaging unit 12 is capable of packaging the identified specific article and the like early.

The robot arm 7 provided in the shipping unit 3 includes the attracting section 7c and attracts the article with the attracting section 7c to grab the article.

The packaging apparatus 4 packages the specific article such that the article can be easily grabbed by the robot arm 7 that grabs the article with suction. For that reason, in the shipping unit 3 of the distribution center 1, a moving time of the article from the commodity box 5 to the delivery box 6 can be reduced. That is, the distribution center 1 can reduce a time required for shipping the article.

The packaging apparatus 4 may not include the sorting unit 11 and the plurality of packaging lanes 31 and may package a specific article and an article that can be bundled conveyed by the conveying unit 30 with a set packaging method. For example, a plurality of packaging robot arms 15 are provided along the conveying unit 30 and the specific article and the article that can be bundled are packaged by a packaging method corresponding to characteristics of the specific article. The packaging apparatus 4 may convey the specific article and the like to one packaging lane 31 and package the specific article and the like with the set packaging method.

Although the present invention is explained above using the embodiments, the technical scope of the present invention is not limited to the scope described in the embodiments explained above. It is apparent to those skilled in the art that various modifications or improvements can be added to the embodiments. It is apparent from the description of the claims that modes to which such changes or improvements are added can also be included in the technical scope of the present invention.

It should be noted that the order of execution of the respective kinds of processing such as the operations, the procedures, the steps, and the stages in the devices, the systems, the programs, and the methods explained in the claims, the specification, and the drawings can be implemented in any order unless “before”, “prior to”, or the like is specifically stated and unless output of preceding processing is used in later processing. Even if the operation flows in the claims, the specification, and the drawings are explained using “first,” , “next,” , and the like for convenience, this does not mean that it is essential to carry out the operation flows in this order.

### REFERENCE SIGNS LIST

1 DISTRIBUTION CENTER
2 STORAGE
3 SHIPPING UNIT
4, 51 PACKAGING APPARATUS
7 ROBOT ARM
7c ATTRACTING SECTION
10 CAMERA
11, 52 SORTING UNIT
12 PACKAGING UNIT
13 INFORMATION PROCESSING DEVICE
15 PACKAGING ROBOT ARM
20 INFORMATION ACQUISITION UNIT
21 STORAGE UNIT
22 CONTROL UNIT
31 PACKAGING LANE
50 PACKAGING SYSTEM
52a STOP MEMBER

1. An article packaging apparatus comprising:
an identification unit that identifies whether or not an article is a specific article unsuitable for being grabbed by a robot arm; and
a packaging unit that, when the article is the specific article, packages the article such that the specific article can be grabbed by the robot arm.

2. The article packaging apparatus according to claim 1, wherein the packaging unit changes a packaging method for the specific article depending on at least one of a shape of the specific article and a material of an exterior member of the specific article.

3. The article packaging apparatus according to claim 1, wherein the article is grabbed by being attracted by an attracting section of the robot arm.

4. A packaging apparatus comprising:
an identification unit that identifies whether or not at least one article stored in a box is a specific article unsuitable for being grabbed by a robot arm; and
a packaging unit that, when the article is the specific article, takes out the article that is the specific article from the box and packages the article taken out from the box such that the specific article can be grabbed by the robot arm.

5. The packaging apparatus according to claim 4, wherein the packaging unit changes a packaging method for the specific article depending on at least one of a shape of the specific article and a material of an exterior member of the specific article.

6. The packaging apparatus according to claim 4, wherein the article is grabbed by being attracted by an attracting section of the robot arm.

7. A packaging system comprising:
the packaging apparatus according to claim 4; and
a conveying unit that conveys the box, wherein
the conveying unit directly conveys the box unloaded from a transport vehicle that transports the box, and
the identification unit identifies whether or not the article stored in the box conveyed by the conveying unit is the specific article.

8. An article packaging apparatus comprising:
an identification unit that identifies whether or not one predetermined article among a plurality of articles is a specific article unsuitable for being grabbed by a robot arm;
a selection unit that, when the predetermined article is identified as the specific article, selects, out of the plurality of articles, an article that can be bundled with the specific article; and
a packaging unit that collectively packages the specific article and the article that can be bundled such that the specific article can be grabbed by the robot arm.

9. The article packaging apparatus according to claim 8, wherein the selection unit selects, depending on a type of the specific article, the article that can be bundled.

10. The article packaging apparatus according to claim 9, wherein the selection unit selects the article that can be bundled, based on at least one of predetermined bundle information indicating the article that can be bundled depending on the type of the specific article and order information including the specific article.

11. The article packaging apparatus according to claim 8, wherein
when the specific article is a plurality of articles that can be collectively packaged,
the selection unit selects the specific article different from the identified specific article as the article that can be bundled, and
the packaging unit collectively packages the identified specific article and the article that can be bundled.

12. The article packaging apparatus according to claim 8, wherein the packaging unit changes a packaging method for the specific article depending on order information for the specific article.

13. The article packaging apparatus according to claim 8, wherein the packaging unit changes a packaging method for the specific article depending on at least one of a shape of the specific article and a material of an exterior member of the specific article.

14. The article packaging apparatus according to claim 8, wherein the identification unit identifies whether or not the one predetermined article among a plurality of the articles conveyed by a conveying unit is the specific article.

15. The article packaging apparatus according to claim 8, wherein the article is grabbed by being attracted by an attracting section of the robot arm.
